(19) United States
(12) Patent Application Publication
(10) Pub. No.: US 2002/0039892 A1
(43) Pub. Date: Apr. 4, 2002

(54) System and method for network and service selection in a mobile communication station

(76) Inventor: Bo Lindell, Lidingo (SE)

Correspondence Address: JENKENS & GILCHRIST, P.C., 3200 Fountain Place, 1445 Ross Avenue, Dallas, TX, 75202-2799, US

(21) Appl. No.: 09/902,516

(22) Filed: Jul. 10, 2001

Related U.S. Application Data
(60) Provisional application No. 60/238,072, filed on Oct. 4, 2000.

(51) Int. Cl. H04B 1/18

(52) U.S. Cl. 455/151.1; 455/151.4

(57) ABSTRACT

In a method and system for selecting an access network and a service therein in a mobile communication station capable of accessing multiple access networks, the availability of each of the access networks can be determined based on the requirements of the application requesting service. A particular access network and service can thereafter be selected from the available access networks based on user preferences.

### CROSS REFERENCE TO RELATED APPLICATION

The present application for patent is related to and hereby claims priority from and incorporates by reference the subject matter disclosed in U.S. patent application Ser. No. 60/238,072 filed Oct. 4, 2000.

### BACKGROUND

1. Field of the Invention

The present invention relates to accessing multiple, access networks in a single mobile communication station and, in particular, to a method and system for selecting an access network.

2. Description of the Related Art

Many mobile communication stations, such as cellular phones, cordless phones, portable computers, digital assistants, pagers, and the like, now have the capability to access more than one access network. These access networks may include cellular networks such as the Global System for Mobile Communications (GSM) and wideband Code Division Multiple Access (WCDMA), direct wireless networks such as Bluetooth and wireless LAN (WLAN), satellite networks, and the like. For example, some mobile communication stations can be used as both a cellular phone under the GSM specification or as a cordless phone under the Digital European Cordless Telephone (DECT) specification. An application in the mobile communication station may then select any of the available access networks to begin communicating with a remote application.

Each access network may provide a number of different services and features therein such as high-speed access, text messaging, call forwarding, and other similar features and services. The mechanisms for accessing these access networks may include radio frequency connections, infrared connections, modem connections, LAN connections, and other similar connections.

The choice of which access network to use may be based on a number of factors including the availability of the access network, the link quality, bit rate, costs, battery consumption, and the like. These factors in turn may depend on a number of other factors. For example, the availability of an access networks may depend on factors such as the current location of the user, the amount of radio interference present, the traffic load on the network, contract or subscription restrictions, and other similar factors.

Availability of an access network may also depend on the specific requirements of the requesting application. For example, “elastic” applications can operate with different bandwidths without being explicitly informed as to the particular bandwidth available. “Adaptive” applications, on the other hand, need to be explicitly informed as to which bandwidth is available. For such adaptive applications, it is useful to determine the bandwidth availability before the service is requested so that an appropriate access network and service may be selected.

One way to select an access network and a particular service therein is by manual selection. The user may select the access network and service based on personal preferences such as speed, costs, and battery consumption. However, such a manual selection process can be cumbersome and often difficult for an untrained user.

Another way to select an access network is to automatically request the access network and service with the highest possible bandwidth and/or bit rate. The actual bandwidth and/or bit rate that will be used may then be negotiated downward between the access network and the mobile communication station if necessary. However, requesting the highest bandwidth and/or bit rate may result in additional or premium costs in some access networks. Moreover, where the application is adaptive, always requesting the highest bandwidth and/or bit rate may cause unnecessary negotiation signaling over the radio interface, which may reduce the network capacity.

Accordingly, it is desirable to be able to provide a convenient way to select an optimal access network and a service therein for a particular application based on the expressed needs of the application and further based on the preferences of the user.

### SUMMARY OF THE INVENTION

The present invention relates to a method and system for selecting an access network and a service in a mobile communication station capable of accessing multiple access networks. The availability of each of the access networks can be determined based on the requirements of the application requesting service. A particular access network and service can thereafter be selected from the available access networks based on user preferences.

In general, in one aspect, the invention is related to a method of selecting an access network from among one or more access networks capable of providing service to a mobile communication station. The method comprises receiving a request for access to an access network, the request including at least one service requirement, and determining an availability of each of at least one access network based on the at least one service requirement. The method further comprises selecting, based on one or more user preferences, an access network determined to be available from the at least one access network, and accessing the selected access network.

In general, in another aspect, the invention is related to a mobile communication station capable of accessing multiple access networks. The mobile communication station comprises a transceiver capable of sending and receiving radio signals to and from the multiple access networks, and a processing unit connected to the transceiver and capable of executing a software program. The software program is configured to receive a request to access an access network from an application executed by the processing unit, the request including at least one service requirement. The software program is further configured to determine an availability of each access network based on the at least one service requirement, and select an access network from said available access networks based on one or more user preferences.

### BRIEF DESCRIPTION OF THE DRAWINGS

For a more complete understanding of the present invention, reference is made to the following detailed description taken in conjunction with the accompanying drawings wherein:

FIG. 1 illustrates a mobile communication station capable of accessing multiple access networks;

FIG. 2 illustrates a functional block diagram of a mobile communication station according to some embodiments of the invention;

FIG. 3 illustrates a network and service selector according to some embodiments of the invention; and

FIG. 4 illustrates a method of selecting an access network and a service according to some embodiments of the invention.

### DETAILED DESCRIPTION OF EXEMPLARY EMBODIMENTS

Following is a detailed description of exemplary embodiments of the present invention wherein reference numerals for like elements are carried forward.

Embodiments of the invention provide a method and system for conveniently selecting an optimal access network and a service therein for a particular application in a mobile communication station that is capable of accessing multiple access networks. In some embodiments, the mobile communication station includes a network and service selector. The network and service selector can receive inputs regarding one or more service requirements of an application requesting service. The service requirements can thereafter be used to determine the availability of each access network. An access network and a service can then be selected from the available access networks based on user preferences.

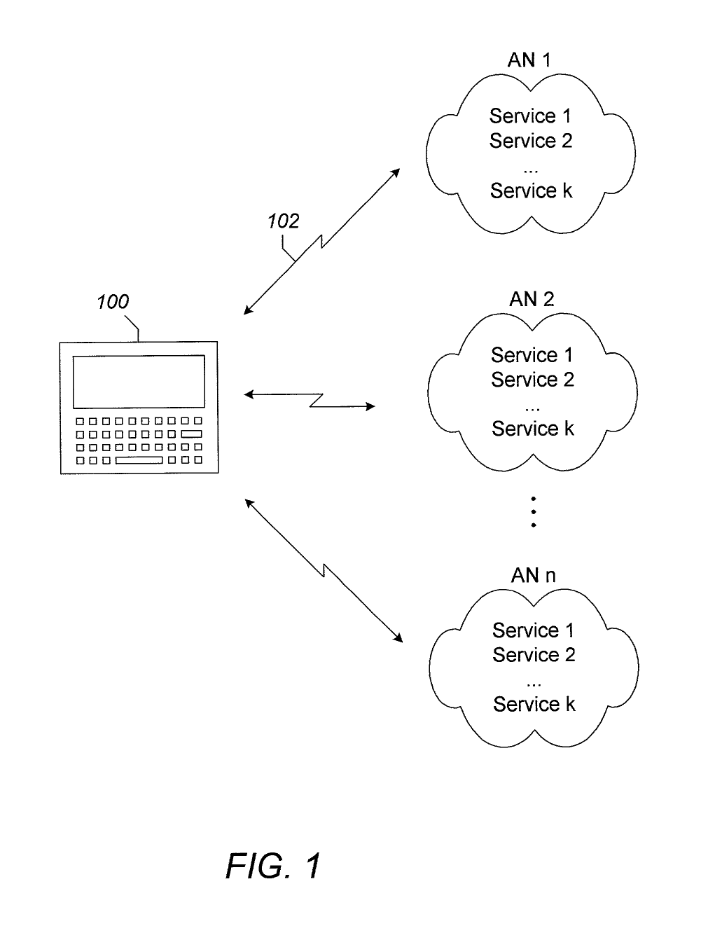

Referring now to FIG. 1, a mobile communication station 100 according to some embodiments of the invention is shown. As mentioned above, the mobile communication station 100 can include a cellular phone, cordless phone, portable computer, digital assistant, pager, and the like, that has the capability to access multiple access networks 1-n. Each access network provides one or more services (e.g., high-speed connection, text messaging, call forwarding) that are generally indicated here as services 1-k. Access to the access networks 1-n and the services 1-k therein may be established via a wireless link such as a radio frequency link 102, or any other suitable connection.

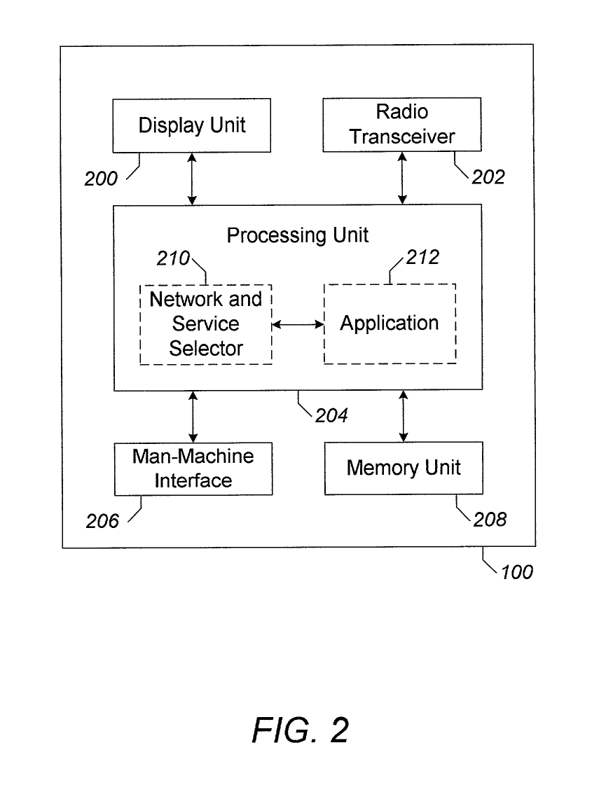

FIG. 2 illustrates a more detailed view of the mobile communication station 100 according to some embodiments of the invention. As can be seen, the mobile communication station 100 can have a number of functional components including a visual display unit 200, a radio transceiver unit 202, a processing unit 204, a man-machine interface 206, and a memory unit 208. Each of these components will now be described below.

The visual display unit 200 can be a standard display unit such as a liquid crystal display and associated software that is capable of visually presenting any text and/or graphical images that may be outputted by the processing unit 204.

The radio transceiver unit 202 can be a standard radio transceiver and associated software that is capable of sending and receiving radio frequency signals to and from the access networks 1-n as needed in order to access and communicate with the access networks.

The processing unit 204 and any operating system running thereon has responsibility for the overall operation of the mobile communication station 100 and can be any suitable data processing unit 204 such as a microprocessor, microcontroller, ASIC, DSP, and the like.

The man-machine interface 206 can include a standard keyboard unit and/or pointing device and associated software that is capable of allowing a user to manually control the mobile communication station 100.

The memory unit 208 has responsibility for the temporary and long-term storage of the data and software applications needed to operate the mobile communication station 100. Examples of the memory unit 208 can include a random access memory, a read-only memory, a magnetic storage media, a removable memory card, or a combination thereof.

In some embodiments, the memory unit 208 is capable of storing, and the processing unit 204 is capable of executing, a network and service selector software program 210. In general, the network and service selector 210 can be configured to select an access network and a service therein from among the plurality of access networks 1-n capable of being accessed by the mobile communication station 100. More specifically, the network and service selector 210 can evaluate the access networks 1-n using the service requirements of an application 212 to determine which of the access networks 1-n are available. Available access networks 1-n can be defined as the networks that are able to satisfy the service requirements of the application 212 which is requesting access to the access networks, and that can currently be accessed by the mobile communication station 100. After the access networks have been determined to be available, the network and service selector 210 can select an access network and at least one service to be used by the application 212 based on one or more predefined user preferences.

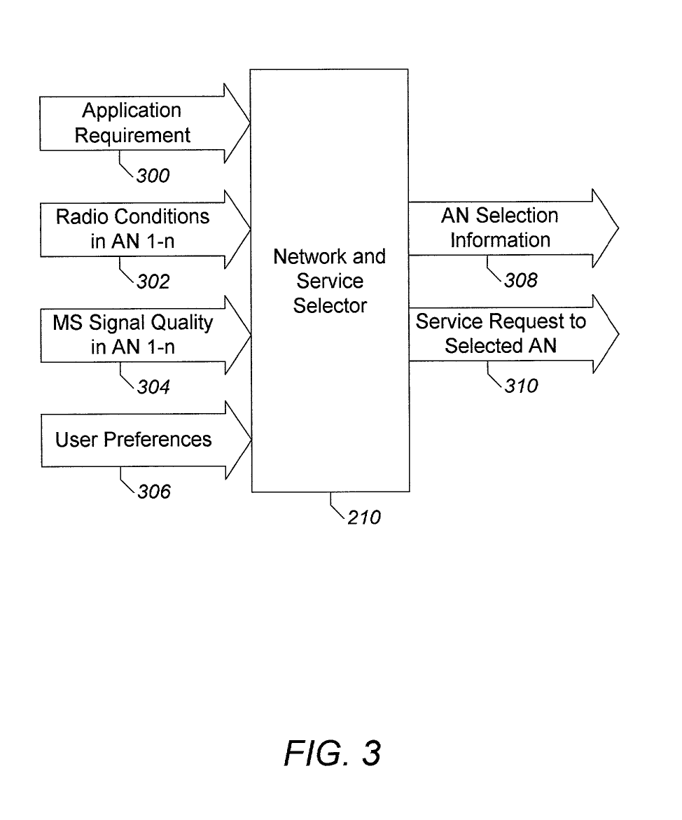

FIG. 3 illustrates the functions of the network and service selector 210 in more detail. As can be seen, in some embodiments, the network and service selector 210 can use the 10 service requirements 300 of an application 212 as an input to determine the availability of the access networks 1-n. In one example, an application 212 such as a video codec may require a bit rate of 32-128 kbps, a maximum transfer delay time, and a maximum frame error rate. Both the GSM and WCDMA networks are accessible to the mobile communication station, but the traffic load is such that the GSM network can only support a service having a bit rate of up to 28 kbps, while the WCDMA network can support a service having a bit rate of up to 128 kbps. In such a scenario, the GSM network would not be able to satisfy the application requirements and, therefore, would not be considered as available to the video codec application 212 based on these service requirements 300.

To determine whether the application requirements can be satisfied, in some embodiments, the network and service selector 210 can use radio link conditions 302 of the access networks 1-n. Such radio link conditions 302 can be derived, for instance, from the signal quality of the broadcast pilot signals of the access networks 1-n (received via the radio transceiver 202). The mobile communication station 100 can continuously monitor the broadcast pilot signals for information such as current traffic loads, downlink power levels (in WCDMA), uplink interference levels, bit error rates, and other similar information from each one of the access networks 1-n. Such information allows the network and service selector 210 to determine the current radio link conditions 302 for the access networks 1-n and, consequently, whether a particular access network is able to satisfy the requirements of the requesting application 212.

In some embodiments, the information carried on the broadcast pilot signals also allows the mobile communication station 100 to estimate whether its own signal quality 304, as received by the access networks 1-n, will be adequate to support the service requirements 300 of the application 212. For example, in WCDMA, the transmit power can be communicated to the mobile communication station on the broadcast pilot signal. The transmit power level can then be combined with the received power level at the mobile communication station to determine a path loss estimation (normally used in open loop power control) for a particular access network. This information can then be used by the network and service selector 210 to further determine which one of the access networks 1-n can be considered available to the requesting application 212.

In some embodiments, upon receiving a request for access to an access network, the network and service selector 210 retrieves one or more user preferences 306 associated with the user of the mobile communication station 100. The user preferences can indicate, for example, the user preferred networks, bit rates, QoS requirements, pricing preferences, and other personal preferences. Such user preferences can subsequently be used by the network and service selector 210 to select one of the available access networks 1-n to be used by the requesting application 212.

For example, where both the GSM and WCDMA access networks are available and have about the same traffic load, the user preferences 306 may indicate a preference for the GSM network. However, where one or the other network has a lower traffic load, the user preferences 306 may indicate a preference for the lower traffic load. Furthermore, where one or the other network has a lower cost due to, for example, marketing and promotional offers, the user preferences 306 may indicate a preference for the less expensive network.

The user preferences can also be used by the network and service selector 210 to select a particular service within the selected access network. For example, assume the selected access network is a WCDMA network, and a range of services 1-k having bit rates of up to 128 kbps are available. The user preferences 306 may indicate a preference for the slower bit rate service due to the premium or additional cost of the faster bit rate services. On the other hand, where the user is primarily concerned about speed, the user preferences 306 may indicate a preference for the faster bit rate services.

In some embodiments, the user preferences are stored and retrieved directly from the mobile communication station 100 via a memory unit 208 such as a random access memory, read-only memory, or other type of memory. In other embodiments, the user preferences 306, along with other types of user information, are stored and retrieved from another memory unit 208 such as a removable subscriber identification module (SIM) connected to the mobile communication station 100. In still other embodiments, the user preferences may be entered manually by the user via the man-machine interface 206.

After the particular access network and services have been selected, the network and service selector 210 can report the selection information 308 back to the requesting application 212. Such information allows the requesting application 212 to be configured (as in the case of an adaptive application) to operate within the available bandwidth and/or other parameters of the selected access network and services, and to make any adjustments that may be needed.

The network and service selector 210 can thereafter issue a service request 310 as an output to the selected access network. Connection with the selected access network can thereafter be establish according to standard connection procedures and protocols.

In some embodiments, the network and service selector 210 is invoked by the requesting application 212 only when there is a request to access the access networks 1-n. In other embodiments, however, the network and service selector 210 can be executed continuously in the background while other applications are running in the mobile communication station 100. Communication between the application and the network and service selector 210 can be established via an application programming interface (API). Such an API (not expressly shown) can include, for example, an enhanced Winsock Generic Quality of Service (GQoS). In general, the GQoS is a subset of the Winsock 2 API that allows a Winsock application to inform the network of its traffic requirements, enabling entitled applications to receive preferential treatment for their traffic.

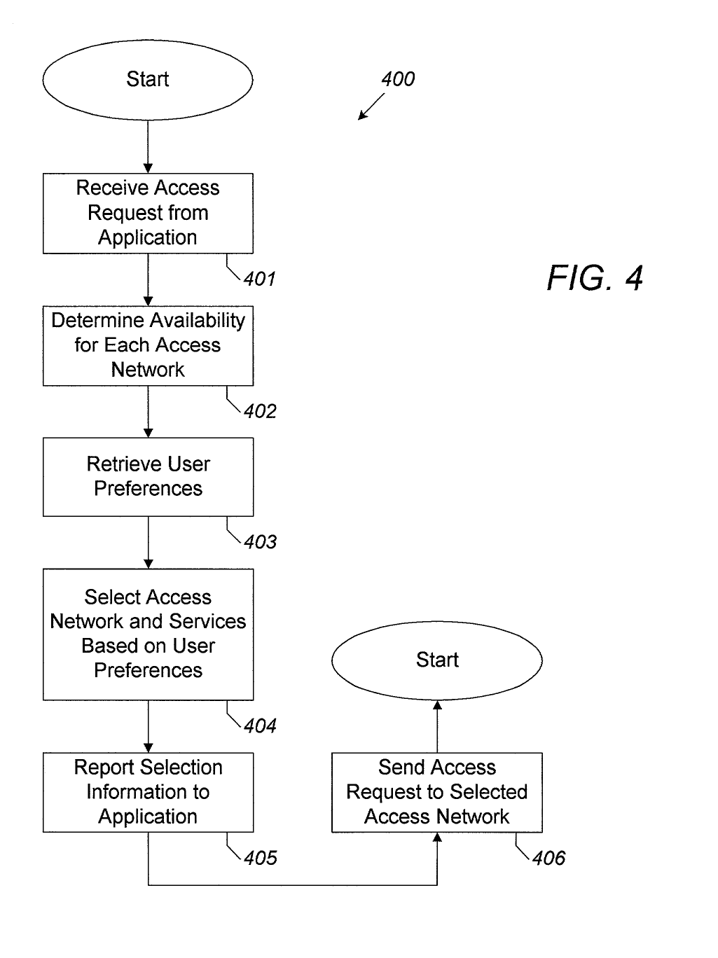

Referring now to FIG. 4, a method 400 of selecting an access network from a multitude of access networks capable of being accessed by one mobile communication station 100 is shown. The method 400 begins when a request is received from an application, including at least one application service requirement, for access to the access networks at step 401. At step 402, a determination is made as to which ones of the access networks and their associated services are available to the application based on the application service requirements and the network conditions. User personal preferences can then be retrieved from a storage location at step 403. At step 404, a particular access network and at least one service are selected from the available access networks based on the user preferences. The selected access network and service information can then be reported to the requesting application at step 405. The application can thereafter be configured and/or adjusted as needed based on the selected network and service. An access request is subsequently issued to the selected access network at step 406, and a connection is then established with the access network in a conventional manner.

As demonstrated above, embodiments of the invention provide a convenient system and method for selecting an optimal access network for a particular application in a multiple network mobile communication station. Those of ordinary skill in the art will recognize that variations and modifications from the described embodiments may be derived without departing from the scope of the invention. For example, although the network and service selector has been described as selecting the access network, in some embodiments, the actual selection can be performed by the requesting application based on the availability information provided by the network and service selector. In some embodiments, the network and service selector can be used for single network mobile communication stations as well as multiple network mobile communication stations. All numerical values disclosed herein are approximate values only regardless of whether that term was used in describing the values. Moreover, unless otherwise specified, the steps of any methods described herein can be practiced in any order or sequence, and some steps can be omitted, combined into a single step, or divided into several sub-steps. Accordingly, the appended claims are intended to cover all such variations and modifications as falling within the scope of the invention.

What is claimed is:

1. A method of selecting an access network from among one or more access networks capable of providing service to a mobile communication station, the method comprising:
receiving a request for access to an access network, said request including at least one service requirement;
determining an availability of each of at least one access network based on said at least one service requirement;
selecting, based on one or more user preferences, an access network determined to be available from said at least one access network; and
accessing said selected access network.

2. The method according to claim 1, further comprising selecting a service type in said selected access network based on said user preferences.

3. The method according to claim 1, further comprising retrieving said user preferences from a user profile stored in said mobile communication station.

4. The method according to claim 1, further comprising retrieving said user preferences from a subscriber identification module.

5. The method according to claim 1, further comprising manually entering said user preferences via a man-machine interface.

6. The method according to claim 1, wherein said user preferences include a lowest service cost.

7. The method according to claim 1, wherein said user preferences include a minimum power consumption.

8. The method according to claim 1, wherein said determining step includes continuously scanning a broadcast pilot signal from each access network.

9. The method according to claim 1, wherein said determining step includes estimating a status of said mobile communication station within each access network.

10. The method according to claim 1, wherein said at least one service requirement includes a bit rate requirement.

11. The method according to claim 1, wherein said at least one service requirement includes a maximum transfer delay.

12. The method according to claim 1, wherein said at least one service requirement includes a maximum frame error rate.

13. A mobile communication station capable of accessing multiple access networks, comprising:
a transceiver capable of sending and receiving radio signals to and from said multiple access networks; and
a processing unit connected to said transceiver and capable of executing a software program, said software program configured to:
receive a request to access an access network from an application executed by said processing unit, said request including at least one service requirement;
determine an availability of each access network based on said at least one service requirement; and
select an access network from said available access networks based on one or more user preferences.

14. The mobile communication station according to claim 13, wherein said software program is further configured to report said access network selection information to said application.

15. The mobile communication station according to claim 13, wherein said software program is further configured to select a service type in said selected access network based on said user preferences.

16. The mobile communication station according to claim 13, wherein said software program is further configured to retrieve said user preferences from a user profile stored in said mobile communication station.

17. The mobile communication station according to claim 13, wherein said software program is further configured to retrieve said user preferences from a subscriber identification module.

18. The mobile communication station according to claim 13, wherein said software program is further configured to accept manually entered user preferences via a man-machine interface.

19. The mobile communication station according to claim 13, wherein said user preferences include a lowest service cost.

20. The mobile communication station according to claim 13, wherein said user preferences include a minimum power consumption.

21. The mobile communication station according to claim 13, wherein said software program is configured to allow said application to select an access network based on said availability of said access networks.

22. The mobile communication station according to claim 13, wherein said software program is configured to continuously monitor a broadcast pilot signal from each access network to determine said access network availability.

23. The mobile communication station according to claim 13, wherein said software program is configured to estimate a status of said mobile communication station within each access network to determine said access network availability.

24. The mobile communication station according to claim 13, wherein said at least one service requirement includes a bit rate requirement.

25. The mobile communication station according to claim 13, wherein said at least one service requirement includes a maximum transfer delay.

26. The mobile communication station according to claim 13, wherein said at least one service requirement includes a maximum frame error rate.
